(19) United States
(12) Patent Application Publication
(10) Pub. No.: US 2026/0313721 A1
(43) Pub. Date: Oct. 8, 2026

(54) Distributed NAS Architecture

(71) Applicant: Apple Inc., Cupertino, CA (US)

(72) Inventors: Vivek G Gupta, San Jose, CA (US); Sudeep Manithara Vamanan, Uttenreuth (DE); Haijing Hu, San Jose, CA (US); Huaning Niu, San Jose, CA (US)

(21) Appl. No.: 19/481,530

(22) PCT Filed: Jun. 14, 2024
(86) PCT No.: PCT/US2024/034148

§ 371 Date: Nov. 4, 2025

Related U.S. Application Data
(60) Provisional application No. 63/511,528, filed on Jun. 30, 2023.

(51) Int. Cl. H04W 76/10; H04W 12/06

(52) U.S. Cl. CPC H04W 76/10; H04W 12/06

(57) ABSTRACT

Apparatuses, systems, and methods for supporting a distributed non-access stratum (NAS) architecture, e.g., in cellular systems. A UE (and/or a processor of a UE) may establish, between the UE and a network node, a wireless connection to support communication with a core network, e.g., communication with one or more network functions of the core network. The UE may establish a direct NAS layer connection with at least two network functions of a plurality of network functions of the core network, e.g., the at least two network functions may each have a corresponding direct NAS layer connection with the UE. In addition, the UE may exchange signaling with the at least two network functions via the corresponding direct NAS layer connection. Thus, the corresponding direct NAS layer connection may be one of a plurality of direct NAS layer connections between the UE and the core network.

### FIELD

The invention relates to wireless communications, and more particularly to apparatuses, systems, and methods for a distributed non-access stratum (NAS) architecture, e.g., in cellular systems.

### DESCRIPTION OF THE RELATED ART

Wireless communication systems are rapidly growing in usage. In recent years, wireless devices such as smart phones, wearable devices or accessory devices), and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE.

Further, with the advent of cloud computing, distributed communication, network disaggregation, end-to-end (E2E) services, and more vertical solutions, there is a need to examine the functionality of radio access networks (RAN) and core network (CN) entities and evolve the 3GPP system architecture with a more cross functional approach, taking into account factors such as user density, multiple access and backhaul technologies, transport efficiency across network elements, efficient transition across user states, cost efficiency and network scalability.

### SUMMARY

Embodiments relate to wireless communications, and more particularly to apparatuses, systems, and methods for supporting a distributed non-access stratum (NAS) architecture, e.g., in cellular systems.

For example, in some embodiments, a UE (and/or a processor of a UE) may be configured to establish, between the UE and a network node, a wireless connection to support communication with a core network, e.g., communication with one or more network functions of the core network. The UE may be further configured to establish a direct NAS layer connection with at least two network functions of a plurality of network functions of the core network. In other words, the at least two network functions may each have a corresponding direct NAS layer connection with the UE. In addition, the UE may be configured to exchange signaling with the at least two network functions via the corresponding direct NAS layer connection. Thus, the corresponding direct NAS layer connection may be one of a plurality of NAS layer connections between the UE and the core network.

As another example, in some embodiments, a wireless connection may be established between a UE, such as UE 106, and a network node (e.g., a RAN DU of a base station). The wireless connection may support communication with a core network, e.g., communication with one or more network functions of the core network. In addition, the network node may support a direct NAS layer connection between the UE and at least two network functions a plurality of network functions of the core network. In other words, for each of the at least two network functions of the core network, a corresponding direct NAS layer connection with the UE may be supported by the network node.

As a further example, in some embodiments, a network function of a core network may be configured to establish, with a UE, a security context for a direct NAS layer connection to the UE. The security context may be based on an autonomous security context that may have been previously established by the UE via an authentication and security mode control procedure with the core network. In addition, the network function may be configured to exchange, via a network node (e.g., RAN DU of a base station), signaling with the UE via the direct NAS layer connection. The direct NAS layer connection may be one of a plurality of direct NAS layer connections between the UE and the core network supporting direct UE access to a corresponding plurality of network functions.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIGS. 5A-5C illustrate examples of network architectures.

FIG. 6A illustrates an example of a network architecture including an access and mobility management function (AMF).

FIG. 6B illustrates examples of core network connections/interfaces supported by an AMF.

FIGS. 7A and 7B illustrate examples of distributed non-access stratum (NAS) architectures, according to some embodiments.

FIG. 8 illustrates another example of a distributed NAS architecture, according to some embodiments.

FIG. 9 illustrates an example of a control plane protocol stack supporting a distributed NAS architecture, according to some embodiments.

FIGS. 10, 11, and 12 illustrate block diagrams of examples of methods for wireless communication, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
DL: Downlink
UL: Uplink
LTE: Long Term Evolution
NR: New Radio
5GS: 5G System
CN: Core Network
RAN: Radio Access Network
NAS: Non-Access Stratum

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi or Wireless Fidelity) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, 5G NR and/or 6G (or equivalent, e.g., a next generation of cellular access standard after 5G NR). In general, 3GPP access refers to various types of cellular access technologies.
Non-3GPP Access—refers to any accesses (e.g., radio access technologies) that are not specified by 3GPP standards. These accesses include, but are not limited to, Wi-Fi, WLAN, and/or fixed networks. Non-3GPP accesses may be split into two categories, “trusted” and “untrusted”: Trusted non-3GPP accesses can interact directly with an evolved packet core (EPC) and/or a core network (CN) whereas untrusted non-3GPP accesses interwork with the EPC/CN via a network entity, such as an Evolved Packet Data Gateway and/or a RAN gateway. In general, non-3GPP access refers to various types of non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

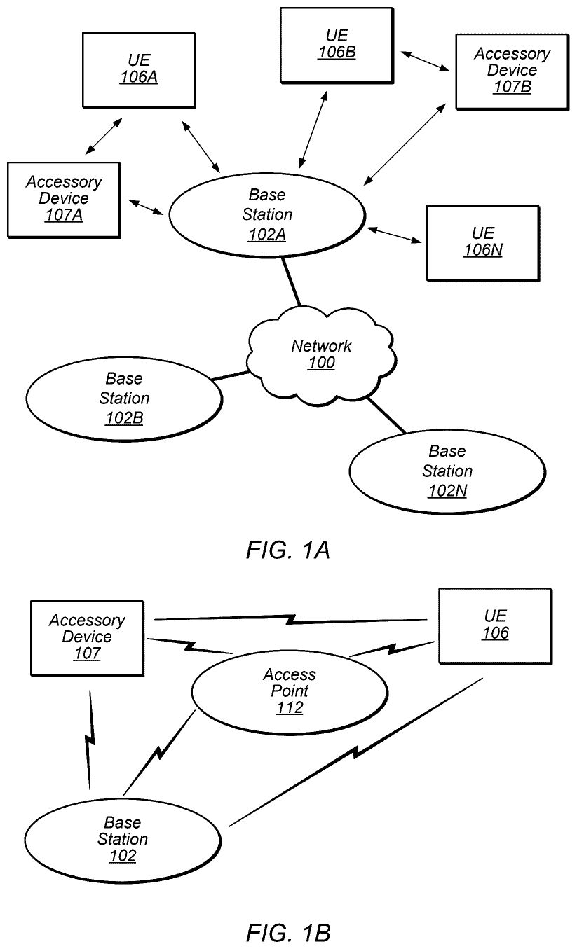

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as LTE, LTE-Advanced (LTE-A), 5G new radio (5G NR), 6G (or equivalent), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. Note that if the base station 102A is implemented in the context of 6G (or equivalent, e.g., such as 5G enhanced, 5G evolution, and so forth), it may include one or more radio units (RUs) and/or one or more distributed units (Dus) and may be referred to as a RAN distributed unit (RAN-DU), a 6G nodeB and/or another name.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 6G base station. In some embodiments, the base station 102A may be connected to a legacy evolved packet core (EPC) network and/or to a next generation core (NGC) network. In addition, the base station 102A cell may include one or more transition and reception points (TRPs). In addition, a UE capable of operating according to 6G may be connected to one or more TRPs within one or more base stations 102A.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., LTE, LTE-A, 5G NR, 6G (or equivalent), etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102Aand hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, LTE/LTE-Advanced, 5G NR, or 6G (or equivalent) using a single shared radio and/or LTE, LTE-Advanced, 5G NR, or 6G (or equivalent) using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or 6G (or equivalent)), and separate radios for communicating using each of Wi-Fi and Bluetooth. Other configurations are also possible.

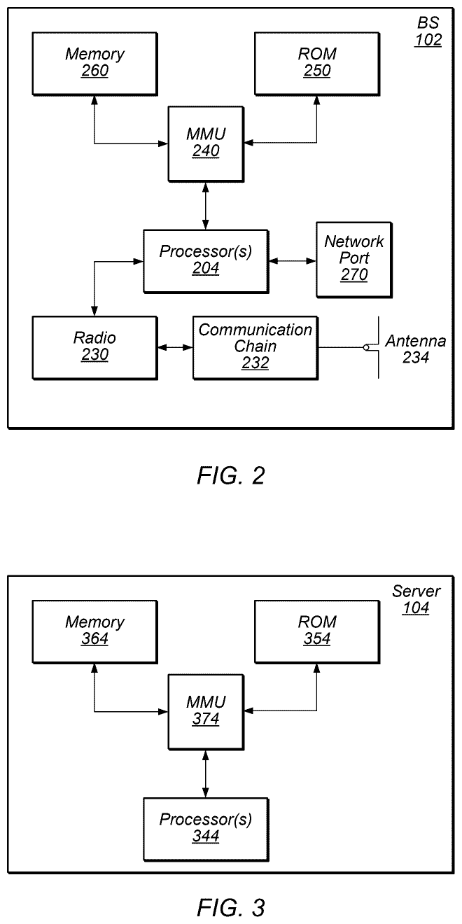

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 6G base station. In some embodiments, the base station 102 may be connected to a legacy evolved packet core (EPC) network and/or to a next generation core (NGC) network. In addition, the base station 102 cell may include one or more transition and reception points (TRPs). In addition, a UE capable of operating according to 6G may be connected to one or more TRPs within one or more base stations 102.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 6G (or equivalent), 5G NR, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include a 6G radio for performing communication according to 6G as well as a 5G NR radio for performing communication according to 5G NR. In such a case, the base station 102 may be capable of operating as both a 6G base station and a 5G NR base station. As another possibility, the base station 102 may include a multi-mode radio which is capable of performing communications according to any of multiple wireless communication technologies (e.g., 6G and Wi-Fi, 5G NR and Wi-Fi, LTE and Wi-Fi, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 6G radio access network. In some embodiments, the server 104 may be connected to a legacy evolved packet core (EPC) network, an NR core network, and/or to a 6G core network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

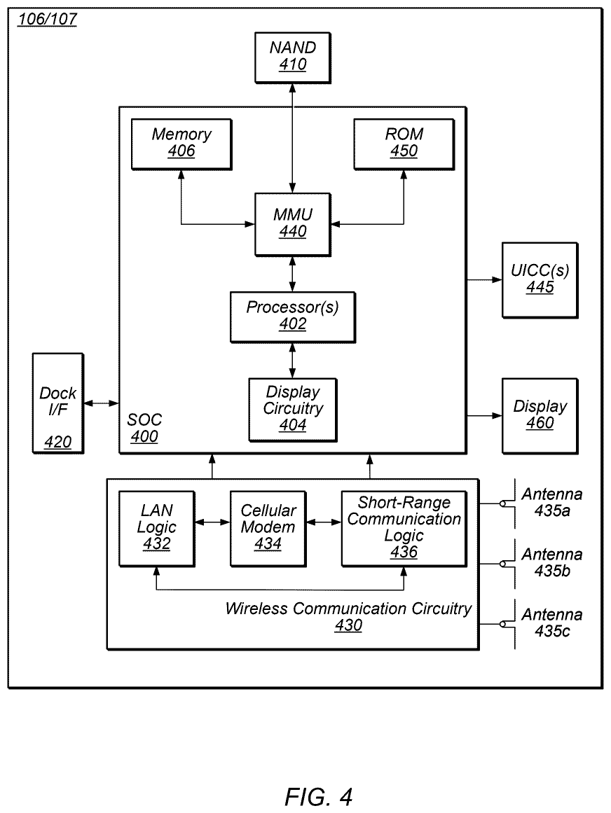

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR, LTE, GSM, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE or 5G NR and a second receive chain for 6G). In addition, in some embodiments, cellular modem 434 may include a single transmit chain that may be switched between radios dedicated to specific RATs. For example, a first radio may be dedicated to a first RAT, e.g., 5G NR or LTE, and may be in communication with a dedicated receive chain and a transmit chain shared with an additional radio, e.g., a second radio that may be dedicated to a second RAT, e.g., 6G, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VOLTE) technology, voice over NR (VONR) technology, and/or voice over 6G technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for supporting a distributed non-access stratum (NAS) architecture, e.g., in cellular systems, as further described herein.

As described herein, the communication device 106/107may include hardware and software components for implementing the above features for a communication device 106/107to communicate a scheduling profile for power savings to a network. The processor 402 of the communication device 106/107may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

### Distrubuted NAS Architecture

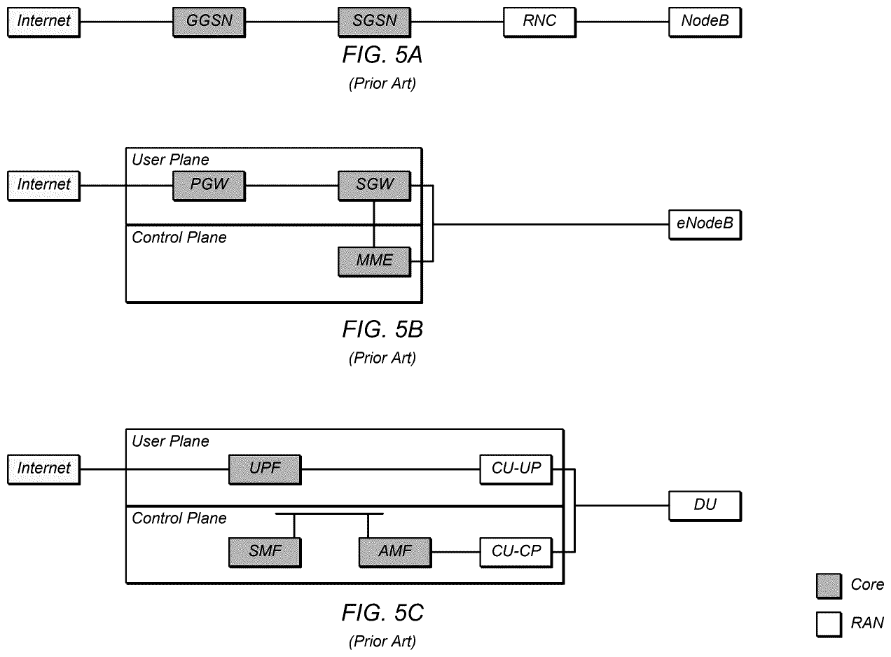

As 3GPP system architecture has evolved from 3G to 4G to 5G, radio access network (RAN) architecture has evolved from a flat RAN (e.g., in 3G) to a distributed and disaggregated RAN (e.g., 5G), e.g., as illustrated by FIGS. 5A, 5B, and 5C. FIG. 5A illustrates an example of a 3G architecture (e.g., flat RAN) in which a nodeB (e.g., base station) connects to a radio network controller (RNC) to form the RAN. The RNC interfaces with a serving general packet radio service (GPRS) support node (SGSN) that further interfaces with a gateway GPRS support node (GGSN). the SGSN and GGSN form the core network and the GGSN interfaces with the Internet. The SGSN provided mobility management and session management, among other functions, while the GGSN handled inter-working between the 3G packet switched network and external packet switched networks. FIG. 5B illustrates an example of a 4G architecture in which an enhanced NobeB (eNodeB) interfaces with a serving gateway (SGW) and a mobility management entity (MME). The eNodeB is essentially the RAN in the 4G architecture while the core network is now split between a control plane (MME) and a user plane (SGW plus the packet gateway (PGW). The user plane interfaces with the Internet. In 4G, the MME was a key component of the Evolved Pack Core (EPC) and provided mobility and session management for the network and supported subscriber authentication, roaming and handovers to other networks. Further, the SGW acted as a user plane boundary between the RAN and the EPC and transferred data from the eNodeB to the PGW which was the network node that connected the EPC to external IP networks. FIG. 5C illustrates an example of a 5G architecture in which a distributed unit (DU)/gNodeB interfaces with a user plane (UP) centralized unit (CU) and a control plane (CP) CU to form the RAN. Note that in general a CU is mainly responsible for non-real-time higher layer 2 and layer 3 (e.g., network layer) functions (such as SDAP, PDCP, and RRC) whereas a DU is mainly responsible for real-time layer 1 (e.g., physical layer) and lower layer 2 functions which contains the data link layer and scheduling function (RLC, MAC and PHY). A DU may include software that may be deployed on site near a radio unit (RU). A CU may include software that may be deployed in a cloud (e.g., on a server) and may interface with a DU via an F1 interface and can manage one or more DUs. The CP CU (e.g., CU-CP) interfaces with an access and mobility management function (AMF). The control plane also includes a session management function (SMF) that interfaces with the AMF, among other network functions/entities. The AMF is an evolution of the MME and terminates the control plane of different access networks onto the 5G core network and controls which devices can access the 5G core network and exchange traffic with data network. The SMF keeps track of PDU sessions and quality of service (QOS) flows in the 5G core network and ensures their states and status in sync between network functions in the control plane and user plane. The user plane CU (e.g., CU-UP) interfaces in the user plane with the user plane function (UPF), which connects the RAN with the Internet. In the 5G architecture, the SMF, AMF, and UPF form the core network (along with multiple other core network functions).

As can be seen from the evolution from 3G to 4G to 5G, there has been increasing decentralization between the RAN and core network. The control and user plan split has been extended from the core network to the RAN and the service-based architecture in the core network has extended to the RAN. In fact, service-based architecture (SBA) is one of the main innovations and paradigm changes in 5G compared to the peer-to-peer signaling interfaces of the previous generations of 3GPP core network. This allows new services to be added in the 5G core network without defining new interfaces and can be implemented as virtualized software functions in a cloud domain. Further, this paradigm change of SBA is now extending from the core network to the RAN as all intra-5G core network interfaces in 5GS have been defined as Service-Based Interfaces (SBI) except for the N2, N4, and N26 interfaces.

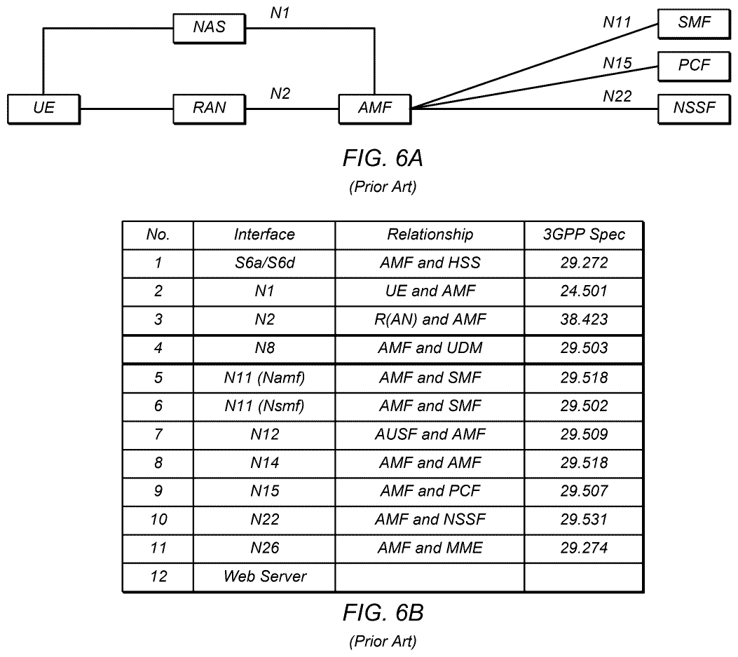

Additionally, in 5GS, the RAN interfaces with the core network via the N2 interface, which allows the NG-RAN to connect with the AMF. The interface is a point-to-point connection which is based on Stream Control Transmission Protocol (SCTP), e.g., as illustrated by FIG. 6A. Further, in 5GS, the non-access stratum (NAS) architecture (e.g., NI interface between UE and AMF) is a single point to point connection between a UE and other 5G core network nodes terminating at the AMF. Thus, the NAS protocol is carried transparently between the UE and AMF. NAS messages include connection management, mobility management, session management, and transport for other functionalities (e.g., UE policy, location, analytics, public warning, and so forth). Note that connection management and mobility management terminate at the AMF whereas the AMF relays messages for other functionalities to other network functions (NFs) based on respective service-based interfaces. Thus, core network nodes such as the SMF, policy control function (PCF), network slice selection function (NSSF), network data analytic function (NWDAF), and so forth communicate indirectly with the UE through the AMF.

This NAS architecture has led to the AMF becoming quiet complex, e.g., as illustrated by the various interfaces/relationships supported by the AMF as shown in FIG. 6B. The AMF interfaces with a multitude of network functions in the 5G core network and serves as a proxy for several 5G core network nodes for NAS signaling between the UE and 5G core network. Further, addition of any new node in the 5G core network invariably impacts the AMF and results in extra hops and increased latency within the AMF architecture. Therefore, improvements are desired.

Embodiments described herein provided systems, methods, and mechanisms for a distributed non-access stratum (NAS) architecture. The NAS architecture described herein addresses issues such as how evolution of N2 into a service-based interface impacts NAS design, how a RAN can communicate directly with multiple core network entities, including how signal routing is handled, which core network entities should have direct communication with RAN nodes, how the NAS architecture can reduce a number of hops and system latency in control plane, how AMF complexity can be mitigated and permit evolution of the core network architecture without a single bottleneck, how piggy backing of information is handled from the core network to the UE for certain operations during registration procedures, how concurrent operations can be handled during simultaneous signaling from UE to multiple network functions, and how security contexts can be established for multiple network functions. In general, the NAS architecture described herein provides a service-based interface between a RAN (e.g., a base station, such as base station 102, operating as a RAN distributed unit (RAN-DU) and a core network, including multiple connections between the RAN-DU and core network, and direct communication between a UE, such as UE 106, and multiple network functions without going through an AMF. Further, the NAS architecture described herein provides increased security protection as a single compromised NAS connection does not affect other NAS connections for the same UE. Additionally, reduced dependency on network functions may offer greater flexibility in their placement as some network functions can be placed at a network edge and may also be placed such that there is one less hop for certain network functions.

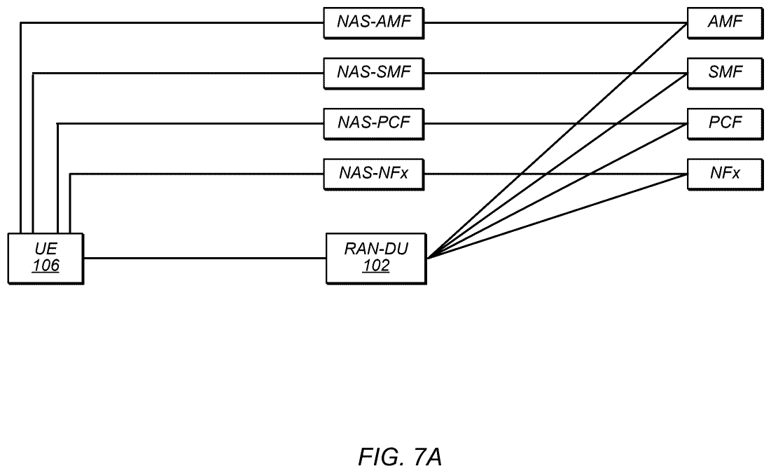

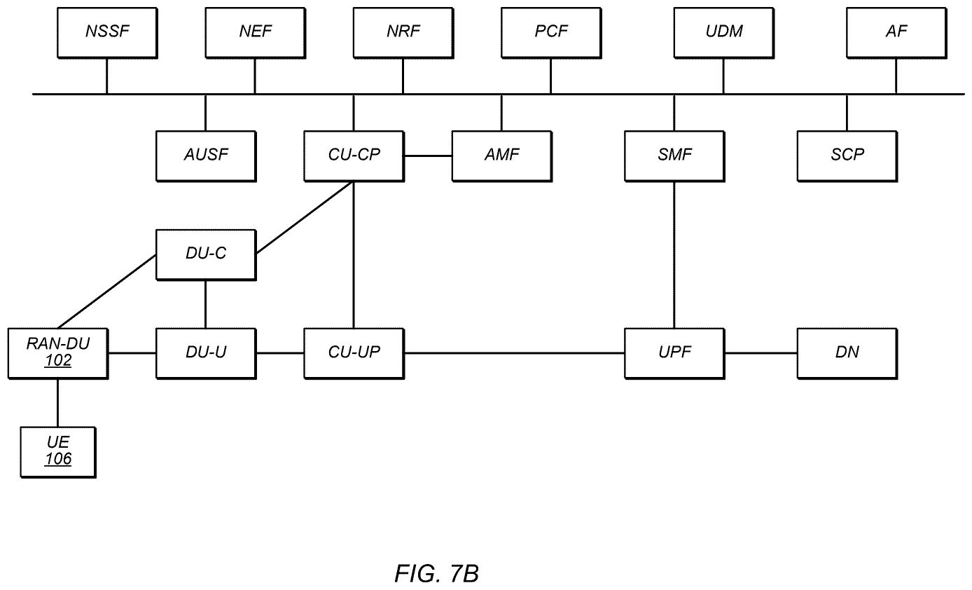

For example, in some instances, a UE may have/support multiple NAS connections with multiple network functions, including an AMF, e.g., as illustrated by FIG. 7A. As shown in FIG. 7A, a UE, such as UE 106, may have a NAS interface with an AMF, an SMF, a PCF, and one or more other network functions, e.g., illustrated as NFx. In addition, a base station, e.g., such as RAN-DU 102 (and/or a RAN-DU implemented on a base station 102), may have direct interfaces with the AMF, the SMF, the PCF and the one or more other network functions, e.g., as illustrated in FIG. 7B. Thus, the UE may access multiple network functions without involvement of the AMF. Such a scheme may provide increased security protection as a single compromised NAS connection may not affect other NAS connections for the UE. Additionally, such a scheme may allow one less hop for NAS connected network functions.

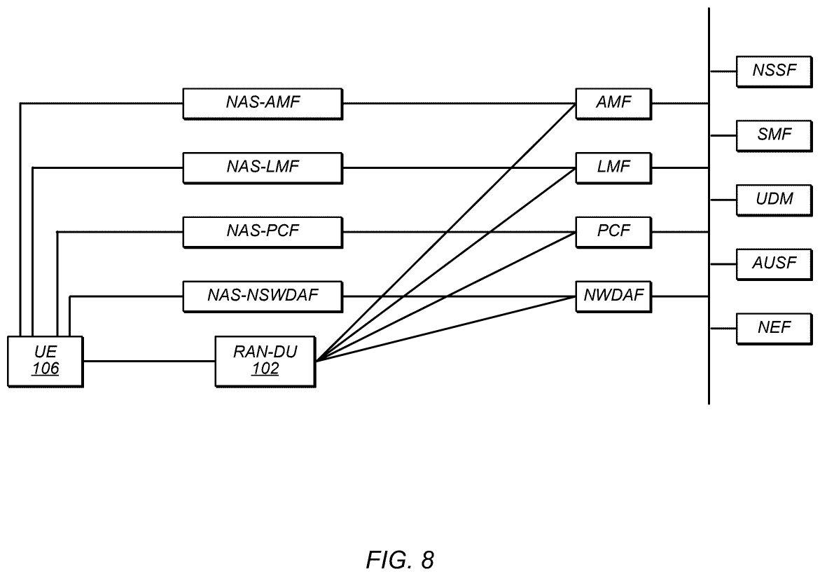

In some instances, the UE may have/support a NAS interface with network functions for which an AMF has limited involvement, e.g., as illustrated by FIG. 8. For example, as shown, the UE may have a NAS interface with the AMF, a location management function (LMF), a policy control function (PCF), and/or an NWDAF. Note that a NAS interface (e.g., a direct NAS connection) to other network functions, such as a compute function, an Artificial Intelligence function (AIF), a machine learning function (MLF), and/or some combination thereof (e.g., such as an AI/ML function (AIMLF)) may also be supported. In other words, the UE may have a direct access to network functions such as the AMF, LMF, PCF, and/or NWDAF, among other possible network functions. In addition, the UE may access other network functions, such as NSSF, SMF, unified data management (UDM), authentication server function (AUSF), and/or a network exposure function (NEF). In other words, the UE may continue to have indirect access to network functions such as NSSF, SMF, UDM, AUSF, and/or NEF. In this manner, network functions not dependent on the AMF are accessed separately, reducing one hop and dependence on the AMF (which may in turn reduce complexity of the AMF) and reduce load on the AMF. Additionally, other network functions may continue to be accessed via the AMF and there may be no need for the RAN-DU to discover these network functions and establish separate connections.

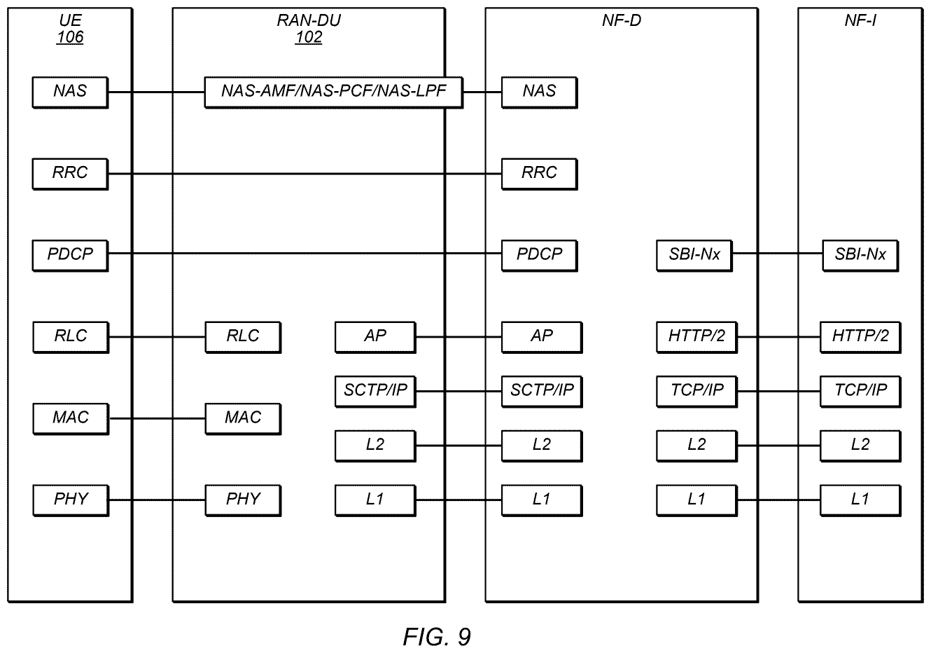

FIG. 9 illustrates an example of a control plane protocol stack for a distributed NAS layer, according to some embodiments. As shown, the distributed NAS protocol stack may include a control plane protocol stack for a UE, such as UE 106, a control plane protocol stack for a RAN distributed unit, such as included in base station 102, a control plane protocol stack for network functions accessed directly by the UE (e.g., NF-D), and a control plane protocol stack for network functions accessed indirectly by the UE (e.g., NF-I). Note that in such a scheme, a RAN centralized unit control plane (e.g., RAN-CU-CP) may be integrated with the core network using a service-based interface. In addition, as shown, an RRC layer connection, typically associated with a RAN-CU-CP, may terminate in the core network as a network function accessed directly by the UE. Further, as shown, the control plane protocol stack of the UE may include a NAS layer, the RRC layer, a packet data convergence protocol (PDCP) layer, a radio link control (RLC) layer, a medium access control (MAC) layer, and/or a physical (PHY) layer. The RLC, MAC, and/or PHY layer may terminate at the RAN-DU (e.g., base station 102). Additionally, the NAS, RRC, and PDCP layer may pass through the RAN-DU 102 and terminate at the NF-D control plane protocol stack, e.g., at network functions accessed directly by the UE. Additionally, the control plane protocol stack of the RAN-DU may include an RLC layer, a MAC layer, a PHY layer, an application (AP) layer, an SCTP/IP layer, an L2 layer, and/or an L1 layer. The NF-D control plane protocol stack may include a NAS layer corresponding to the UE NAS layer (e.g., including NAS connections for network functions directly accessed by the UE, e.g., such as AMF, LMF, PCF, NWDAF, and so forth), an RRC layer corresponding to the UE RRC layer, a PDCP layer corresponding to the UE PDCP layer, an AP layer corresponding to the RAN-DU AP layer, an SCTP/IP layer corresponding to the RAN-DU SCTP/IP layer, an L2 layer corresponding to the RAN-DU L2 layer, and/or an L1 layer corresponding to the RAN-DU L1 layer. Further, the NF-D protocol stack may include one or more service-based interface layer (e.g., SBI-Nx) connections with the NF-I control plane protocol stack to support access to network functions indirectly accessible by the UE. In addition, the NF-D control plane protocol stack may include an HTTP/2 and/or a HTTP/3 layer, a TCP/IP and/or Quick User Datagram Protocol (UDP) Internet Connections (QUIC) based UDP/IP layer, an L2 layer, and/or an L1 layer corresponding to NF-I control plane protocol stack layers. The NF-I control plane protocol stack may include one or more service-based interface layer (e.g., SBI-Nx) connections with the NF-D protocol stack to support access to network functions indirectly accessible by the UE. In addition, the NF-I control plane protocol stack may include an HTTP/2 and/or HTTP/3 layer, a TCP/IP and/or QUIC based UDP/IP layer, an L2 layer, and/or an L1 layer corresponding to NF-D control plane protocol stack layers.

In some instances, connection management (CM), e.g., for establishment, maintenance, and/or release of a security protected RRC connection and NAS signaling connection, may be managed via and/or through a RAN-DU node, such as base station 102. For example, since a UE, such as UE 106, may have independent connections to several network functions, the RAN-DU node may establish a connection with an AMF, a CU-CP and/or other core network nodes/functions with which the UE may need to have a direct connection. Thus, as illustrated (and discussed above in reference to) FIG. 9, the RAN-DU may support multiple NAS connections between the UE and one or more network functions.

In some instances, signal routing to network functions without a direct NAS connection to a UE, such as UE 106, may continue to be handled by an AMF, e.g., as is currently done in 5G NR. However, for network functions with a direct NAS connection to the UE, the AMF will no longer be involved in signal routing.

In some instances, signaling procedures between a UE, such as UE 106, and network functions without a direct NAS connection to a UE may continue to be performed “piggy-backed” during a signaling procedure with an AMF. For example, during a steering of roaming signaling procedure, a container provided by a UDM to the UE during initial registration or some policy related information provided by a PCF during initial registration may be included in signaling between the AMF and UE. In some instances, e.g., such as when a network function has a direct NAS connection to the UE, the UE may initiate a “piggy backing” procedure to include data/information intended for another network function in signaling to the network function.

In some instances, such as when there is simultaneous and/or concurrent signaling exchanges between a UE, such as UE 106, and multiple network functions (e.g., such as with a first network function with a NAS connection to the UE and a second network function with an indirect connection to the UE and/or multiple network functions with NAS connections to the UE) that are dependent on each other to achieve a certain purpose and which may trigger core network internal signaling between the network functions, network functions with a NAS connection to the UE may be responsible for coordinating signaling internally (e.g., within the core network) while network functions indirectly connected to the UE may continue to rely on an AMF (or another network function with a NAS connection to the UE) to coordinate the signaling.

In some instances, when a UE, such as UE 106, needs to establish and/or maintain several security contexts, e.g., each NAS connection may have a corresponding security context, the UE may first establish an autonomous security context via a separate authentication and security mode control procedure. Then additional security contexts, e.g., such as for each NAS connection, may be based on the autonomous security context.

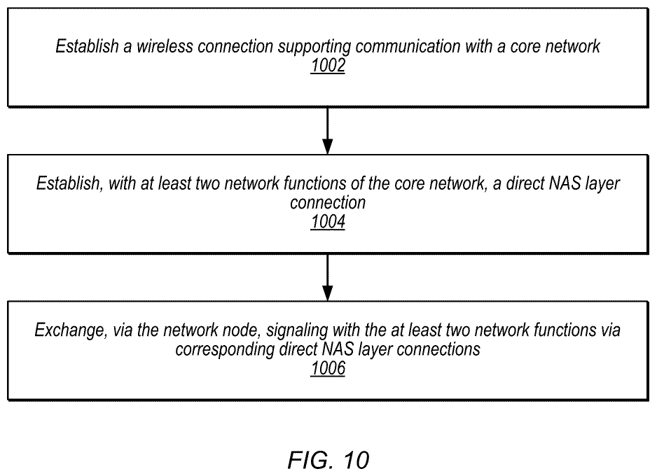

FIG. 10 illustrates a block diagram of an example of a method for wireless communication, according to some embodiments. The method shown in FIG. 10 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1002, a wireless connection may be established between a UE, such as UE 106, and a network node, such as base station 102 (e.g., a RAN DU). The wireless connection may support communication with a core network, e.g., communication with one or more network functions of the core network.

At 1004, a non-access stratum (NAS) layer connection may be established with at least two network functions of a plurality of network functions of the core network. In other words, the at least two network functions may each have a corresponding direct NAS layer connection with the UE, e.g., a first network function may have a first direct NAS layer connection with the UE and a second network function may have a second direct NAS layer connection with the UE (note that the UE may support additional direct NAS layer connections with additional network functions as well). In some instances, the at least two network functions of the plurality of network functions may include at least two of (e.g., two or more of) an access and mobility management function (AMF), a policy control function (PCF), a location management function (LMF), a compute function, an AI function (AIF), an ML function (MLF), an AI/ML function (AIMLF), a session management function (SMF), and/or a network data analytic function (NWDAF). Note that the plurality of network functions may further include other network functions as well.

At 1006, signaling may be exchanged with and/or sent to the at least two network functions of the plurality of network functions via the corresponding direct NAS layer connections. The corresponding direct NAS layer connections may be part of a plurality of direct NAS layer connections to the core network. The signaling may be exchanged and/or sent via the network node. In other words, the signaling may pass through the network node.

In some instances, an indirect connection may be established with one or more additional network functions of the core network. The indirect connection may be via at least one of the plurality of the network functions of the core network, thus forming an indirect NAS layer connection.

In some instances, a control plane protocol stack may include a NAS layer supporting the corresponding direct NAS layer connections. In addition, the control plane protocol stack may also include one or more of a radio resource control (RRC) layer, a packet data convergence protocol (PDCP) layer, a radio link control (RLC) layer, a medium access control (MAC) layer, and/or a physical (PHY) layer. In some instances, one or more of the RLC layer, MAC layer, and/or PHY layer may terminate at a RAN DU. In some instances, one or more of the NAS layer, RRC layer, and/or PDCP layer may interface with the core network via a cloud interface supporting direct access to a first set of core network functions. Further, the cloud interface may also support indirect access to a second set of core network functions via at least one core network function of the first set of core network functions.

In some instances, signaling to at least one of the at least two network functions of the plurality of network functions via the corresponding direct NAS layer connection may include data intended for a network function not supported by the direct NAS layer connection. In other words, signaling on a direct NAS layer connection may include piggy-backed data intended for another network function, e.g., a network function other than the network function supported by the direct NAS layer connection. In sone instances, the at least one of the at least two network functions of the plurality of network functions may be at least one of a PCF, an LMF, a compute function, an AIF, an MLF, an AIMLF, an SMF, and/or an NWDAF. In other words, the at least one of the at least two network functions of the plurality of network functions may be a network function other than an AMF.

In some instances, an autonomous security context may be established via an authentication and security mode control procedure with the core network. Note that the network node may support performance of the authentication and security mode control procedure, e.g., by connecting the UE to the core network. In some instances, a corresponding security context based on the autonomous security context may be established with each of the plurality of network functions of the core network.

In some instances, the method described above in reference to FIG. 10 may be performed by a UE, such as UE 106. In some instances, the method described above in reference to FIG. 10 may be performed by an apparatus (e.g., baseband processor and/or other processing circuitry) of a UE, such as UE 106. In some instances, the method described above in reference to FIG. 10 may be performed by processing circuitry of a UE, such as UE 106, e.g., via execution of program instructions stored in a memory of the UE.

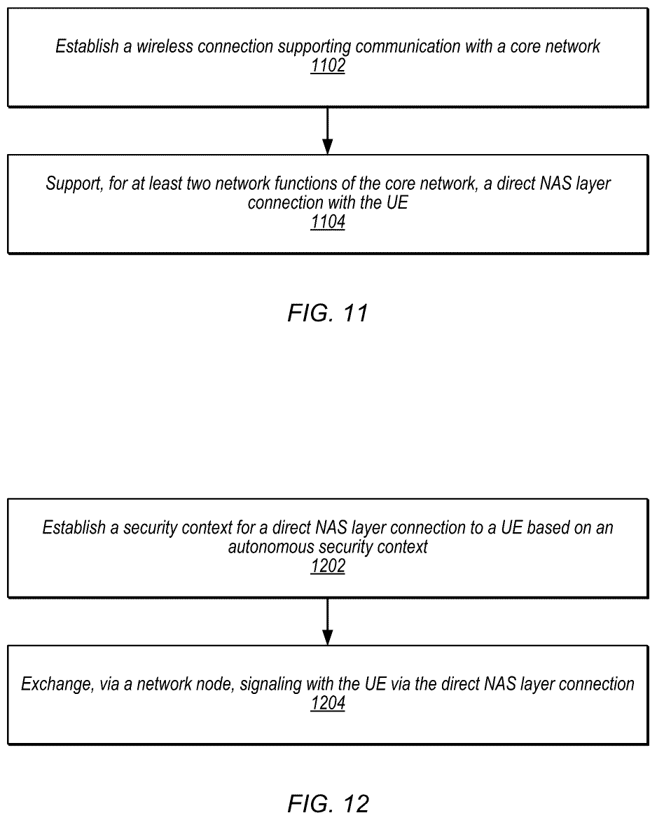

FIG. 11 illustrates a block diagram of another example of a method for wireless communication, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a wireless connection may be established between a UE, such as UE 106, and a network node, such as base station 102 (e.g., a RAN DU). The wireless connection may support communication with a core network, e.g., communication with one or more network functions of the core network.

At 1104, corresponding (direct) NAS layer connections between the UE and at least two network functions of a plurality of network functions of the core network may be supported. In other words, for each of the at least two network functions of the plurality of network functions of the core network, a corresponding direct NAS layer connection with the UE may be supported. Hence, each of the at least two network functions of the plurality of network functions may have a direct NAS layer connection with the UE, e.g., a first network function may have a first direct NAS layer connection with the UE and a second network function may have a second direct NAS layer connection with the UE (note that the UE may support additional direct NAS layer connections with additional network functions as well). In some instances, the at least two network functions of the plurality of network functions may include at least two of (e.g., two or more of) an access and mobility management function (AMF), a policy control function (PCF), a location management function (LMF), a compute function, an Artificial Intelligence (AI) function (AIF), a machine learning (ML) function (MLF), an AI/ML function (AIMLF), a session management function (SMF), and/or a network data analytic function (NWDAF). Note that the plurality of network functions may further include other network functions as well. In some instances, a connection with each of the at least two network functions of the plurality of network functions of the core network may be established on behalf of the UE as part of the support of a direct NAS layer connection with the UE. In addition, signaling between the UE and the at least two network functions of the plurality of network functions may be relayed via corresponding direct NAS layer connections. Note that the corresponding direct NAS layer connections may be part of a plurality of direct NAS layer connections to the core network.

In some instances, a control plane protocol stack may include one or more of a radio link control (RLC) layer, a medium access control (MAC) layer, and/or a physical (PHY) layer. In addition, one or more of the RLC layer, MAC layer, and/or PHY layer terminates at a RAN DU. Note that the RAN DU may be comprised in a base station, such as base station 102.

In some instances, the method described above in reference to FIG. 11 may be performed by a base station and/or a portion of a base station (e.g., a RAN DU), such as base station 102. In some instances, the method described above in reference to FIG. 11 may be performed by an apparatus (e.g., processing circuitry) of a base station, such as base station 102. In some instances, the method described above in reference to FIG. 11 may be performed by processing circuitry of a base station, such as base station 102, e.g., via execution of program instructions stored in a memory of the base station.

FIG. 12 illustrates a block diagram of a further example of a method for wireless communication, according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a network function of a cored network may establish, with a UE, such as UE 106, a security context for a (direct) non-access stratum (NAS) layer connection to the UE. The security context may be based on an autonomous security context. The autonomous security context may have been previously established by the UE via an authentication and security mode control procedure with the core network.

At 1204, the network function may exchange, via a network node, signaling with the UE (and/or send, via the network node, signaling to the UE) via the (direct) NAS layer connection. The (direct) NAS layer connection may be one of a plurality of NAS layer connections between the UE and the core network supporting direct UE access to a corresponding plurality of network functions. The corresponding plurality of network functions may include at least two of an AMF, a PCF, an LMF, a compute function, an AIF, an MLF, an AIMLF, an SMF, and/or an NWDAF. The network node may be a RAN DU. The RAN DU may be comprised in a base station, such as base station 102.

In some instances, the network function may establish, with one or more additional network functions of the core network, an indirect connection to the UE.

In some instances, the network function may receive, from the UE, data intended for a network function not supported by a (direct) NAS layer connection to the UE. The network function may forward, to the network function not supported by a (direct) NAS layer connection to the UE, the data.

In some instances, the network function may receive, from the UE, signaling associated with a service, wherein the service is dependent on coordination between at least two network functions. The network function may coordinate, with at least one of the at least two network functions, the signaling associated with the service. In such instances, the network function may be one of a PCF, an LMF, a compute function, an AIF, an MLF, an AIMLF, an SMF, and/or an NWDAF. In other words, the network function may be a network function other than an AMF.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for wireless communication, comprising:
establishing, with at least two network functions of a plurality of network functions of a core network, a corresponding direct non-access stratum (NAS) layer connection; and
sending, via a network node, signaling to the at least two network functions of the plurality of network functions via the corresponding direct NAS layer connections.

2. The method of claim 1,
wherein the at least two network functions of the plurality of network functions includes at least two of:
an access and mobility management function (AMF);
a policy control function (PCF);
a location management function (LMF);
a compute function;
an Artificial Intelligence (AI) function (AIF);
a machine learning (ML) function (MLF);
an AIMLF;
a session management function (SMF); or
a network data analytic function (NWDAF).

3. The method of claim 1, further comprising:
establishing, with one or more additional network functions of the core network, an indirect connection via at least one of the at least two network functions of the plurality of the network functions of the core network.

4. The method of claim 1,
wherein the network node comprises a radio access network (RAN) distributed unit (DU).

5. The method of claim 1,
wherein a control plane protocol stack comprises a NAS layer supporting the corresponding direct NAS layer connections, and wherein the control plane protocol stack further comprises one or more of:
a radio resource control (RRC) layer;
a packet data convergence protocol (PDCP) layer;
a radio link control (RLC) layer;
a medium access control (MAC) layer; or
a physical (PHY) layer.

6. The method of claim 5,
wherein one or more of the RLC layer, MAC layer, or PHY layer terminates at a radio access network (RAN) distributed unit (DU).

7. The method of claim 5,
wherein one or more of the NAS layer, RRC layer, or PDCP layer interfaces the core network via a cloud interface supporting direct access to a first set of core network functions.

8. The method of claim 7,
wherein the cloud interface further supports indirect access to a second set of core network functions via at least one core network function of the first set of core network functions.

9-13. (canceled)

14. A method for wireless communication, comprising:
a network function,
establishing, with a user equipment device (UE), a security context for a non-access stratum (NAS) layer connection to the UE, wherein the security context is based on an autonomous security context; and
sending, via a network node, signaling to the UE via the NAS layer connection, wherein the NAS layer connection is one of a plurality of NAS layer connections between the UE and a core network supporting direct UE access to a corresponding plurality of network functions.

15. The method of claim 14,
wherein the corresponding plurality of network functions includes at least two of:
an access and mobility management function (AMF);
a policy control function (PCF);
a location management function (LMF);
a compute function;
an Artificial Intelligence (AI) function (AIF);
a machine learning (ML) function (MLF);
an AIMLF;
a session management function (SMF); or
a network data analytic function (NWDAF).

16. The method of claim 14, further comprising:
the network function,
establishing, with one or more additional network functions of the core network, an indirect connection to the UE.

17. The method of claim 14,
wherein the network node comprises a radio access network (RAN) distributed unit (DU).

18. The method claim 14, further comprising:
the network function,
receiving, from the UE, data intended for a network function not supported by a NAS layer connection to the UE; and
forwarding, to the network function not supported by a NAS layer connection to the UE, the data.

19. The method of claim 14,
the network function,
receiving, from the UE, signaling associated with a service, wherein the service is dependent on coordination between at least two network functions; and
coordinating, with at least one of the at least two network functions, the signaling associated with the service.

20. The method of claim 14,
the network function comprises one of:
a policy control function (PCF);
a location management function (LMF);
a compute function;
an Artificial Intelligence (AI) function (AIF);
a machine learning (ML) function (MLF);
an AIMLF;
a session management function (SMF); or
a network data analytic function (NWDAF).

21. An apparatus, comprising:
a memory; and
at least one processor in communication with the memory and configured to cause a user equipment device (UE) to perform operations comprising:
establishing, with at least two network functions of a plurality of network functions of a core network, a corresponding direct non-access stratum (NAS) layer connection; and
sending, via a network node, signaling to the at least two network functions of the plurality of network functions via the corresponding direct NAS layer connections.

22. The apparatus of claim 21
wherein the at least one processor is further configured to cause the UE to perform operations comprising:
including, in signaling to at least one of the at least two network functions of the plurality of network functions via at least one corresponding direct NAS layer connection, data intended for a network function not supported by the at least one corresponding direct NAS layer connection.

23. The apparatus of claim 22,
wherein the at least one of the plurality of network functions comprises at least one of:
a policy control function (PCF);
a location management function (LMF);
a compute function;
an Artificial Intelligence (AI) function (AIF);
a machine learning (ML) function (MLF);
an AIMLF;
a session management function (SMF); or
a network data analytic function (NWDAF).

24. The apparatus of claim 21,
wherein the at least one processor is further configured to cause the UE to perform operations comprising:
establishing, via the network node, an autonomous security context via an authentication and security mode control procedure with the core network.

25. The apparatus of claim 24,
wherein the at least one processor is further configured to cause the UE to perform operations comprising:
establishing, with each of the plurality of network functions of the core network, a corresponding security context based on the autonomous security context.
